(19) United States
(12) Patent Application Publication
(10) Pub. No.: US 2009/0122748 A1
(43) Pub. Date: May 14, 2009

(54) Method and System for the Dynamic Adaptation of Service Quality Metrics in an Adhoc Network

(75) Inventors: Yvon GOURHANT, Lannion (FR); Djamal-Eddine MEDDOUR, Lannion (FR); Laurent REYNAUD, Trevou-Treguignec (FR)

Correspondence Address: COHEN, PONTANI, LIEBERMAN & PAVANE LLP, 551 FIFTH AVENUE, SUITE 1210, NEW YORK, NY, 10176, US

(73) Assignee: FRANCE TELECOM, Paris (FR)

(21) Appl. No.: 11/792,016

(22) PCT Filed: Nov. 30, 2005
(86) PCT No.: PCT/FR05/51010

§ 371 Date: Sep. 28, 2007

(30) Foreign Application Priority Data
Dec. 1, 2004 (FR) 0412733

(51) Int. Cl. H04W 28/24

(52) U.S. Cl. 370/328

(57) ABSTRACT

A method and system for dynamically managing quality of service metrics in an ad hoc network including a plurality of routing nodes (100) that are used to route data packets. The system also includes a network manager (200) that is used to determine, compute and deploy a quality of service metric to be applied at a given time based on the quality of service available on the network and on the quality of service required by one or more applications. Each node includes a metric manager (111) that updates routing tables (1121) of the nodes as a function of the received quality of service metric to be applied.

### FIELD OF THE INVENTION AND PRIOR ART

The present invention relates to the quality of service of routing in ad hoc networks, which are communication networks using the radio medium. They consist of mobile and/or fixed nodes having the property of automatically and dynamically constructing a network capable of routing packets from any point of the network to any other once radio communication is established between a node and its neighbors.

In an ad hoc network, packets are sent from the source node to the destination node either directly if the destination node is in the connectivity area of the source node or via adjacent intermediate nodes if the destination node is out of range of the source node.

Consequently, ad hoc networks can instantaneously deploy communication networks with no pre-existent infrastructure and no centralized management. The network is formed dynamically, all management tasks being distributed between all nodes of the network.

The main feature of ad hoc networks is that the network nodes function, or can function, as routers. The nodes themselves are therefore responsible for setting up and maintaining the continuous connectivity of the network, using specific routing protocols that enable exchange of routing information between adjacent nodes and computation of communication paths to all other nodes of the network. These routing protocols periodically send messages for updating the topology of the ad hoc network (i.e. for identifying nodes and links between nodes).

There are two families of routing protocols: proactive routing protocols and reactive routing protocols.

For protocols in the family of proactive protocols, each node has an overview of the entire network by means of the periodic exchange of routing tables. All paths are available directly via the routing table.

For protocols in the family of reactive protocols, paths are available only on demand. If a path to a destination is not available from the routing table, a path search request is launched, the result of that request enabling a path to be found, if there is one.

Proactive routing protocols and in particular the OLSR (optimized link state routing) protocol are more particularly relevant to the present invention.

FIG. 1 represents the components of the OLSR protocol, which is a proactive routing protocol. This protocol has two main components: a topology maintenance component 10 including a topology control module 11 connected to a routing node selection module 12, and a path selection component 20 including a path computation module or algorithm 21. By periodically exchanging control messages, the topology maintenance component 10 constructs the topology graph of the network used thereafter to compute paths. This mechanism also minimizes the network traffic overhead by using a multipoint relay (MPR) router node selection mechanism.

From information gathered regarding the topology, the path selection component 20 computes the best routes between the nodes of the network using a graphical path computation algorithm (for example Dijkstra's algorithm), the path selection criterion being the number of hops.

Ad hoc proactive routing protocols were basically designed without explicitly considering the quality of service in respect of path computation. The criterion adopted by these protocols is generally the number of hops. It is clear that such a criterion is inadequate for real-time applications such as videoconference applications and telephony applications.

Taking quality of service into account in the routing protocol entails, at the design stage, predefining new criteria, called quality of service metrics, as part of the path selection process. Under such circumstances, as shown in FIG. 1, the path selection component 20 further includes a quality of service metric management module 22 associated with the path computation algorithm 21. Examples of these metrics are delay metrics, bandwidth metrics, jitter metrics, etc. Information concerning the quality of service metrics is injected into the topology graph. A new graph enriched with this quality of service information is therefore constructed and paths are computed taking account of these metrics.

In the prior art, the decision concerning the selection of a quality of service metric, which serves as a path selection criterion, is programmed statically. Consequently, it is impossible to change these criteria once the routing protocol is implemented.

Note also that the known solutions provide for the use of a single metric or a predefined combination of metrics with a view to optimization in a given situation (bandwidth or delay, reliability, energy, etc.). However, the limitations that result from static management of these metrics quickly make themselves felt. If one or more applications executed in an ad hoc network are used conjointly to determine routes based on a routing algorithm using an inadequate metric, the quality of service rendered to those applications is not the best, especially given that the constraints of the applications in terms of quality metrics generally differ.

One solution for alleviating these limitations is selecting multi-metric (or multi-criteria) paths, which entails defining an algorithm capable of finding the best paths for all possible metrics. However, it is impossible to implement any such algorithm, which corresponds to what are known as NP-complete problems in the theory of the complexity of decision problems in electronic data processing (a decision problem is referred to as an NP-complete problem if it is in the class of problems for which the yes response can be decided on by a non-deterministic algorithm in a polynomial time relative to the size of the instance and if any NP-complete problem can be rewritten by means of a polynomial algorithm as a subset of instances of that problem). Heuristics-based approximate computation techniques exist but are limited to a predefined number of metrics and are also static. Consequently, the same limitations are present as in the first situation.

### OBJECT AND BRIEF DESCRIPTION OF THE INVENTION

The present invention aims to solve the above-mentioned problems and to propose a technical solution for adapting a routing protocol, in particular of proactive type (such as the OLSR protocol), to enable quality of service metrics used to compute paths in ad hoc networks to be changed and applied dynamically, taking account of network characteristics and/or resources needed by the applications used.

The above objective is achieved by means of a method of dynamically adapting quality of service metrics that includes the following steps:

a) determining a quality of service metric to be applied at a given time based on the quality of service available on the network and/or on the quality of service required by one or more applications;

b) sending the quality of service metric to be applied to at least some network nodes, which includes modules for calculating quality of service metrics and inserting them in the control packets of the routing protocol; and

c) updating a routing table of the nodes as a function of the received instantaneous quality of service metric to be applied.

This method therefore enables dynamic application to the routing protocol of the quality of service metric that best matches environmental constraints (number of nodes, density, degree of mobility, etc.) and/or the status of the network (resources available and/or applications running).

By applying dynamically the quality of service metric that is the most pertinent at a given time, the mechanisms described here efficiently address the intrinsically dynamic behavior of ad hoc networks.

To this end, there are two options in step a). In the first, each node analyses exchanges with its neighbors and decides on the selected metric itself, as in self-organized networks. The second uses a network manager that supervises the status of the resources of each node and/or the resources requested by the applications running on the network. It decides on and applies the modules needed to manage the appropriate quality of service metrics.

In step b), the quality of service metrics to be applied are inserted into control messages of the routing protocol. In this way any new quality of service metric to be applied is propagated over the network via generic control messages, a metric manager in each node extracting the data relating to that metric. This avoids having to rewrite the routing protocol on each change of quality of service metric.

In step c), paths can be computed and the routing table can be updated as a function of quality of service metrics received directly from the path computation module of the routing protocol or from a path computation module external to the protocol. When using a module external to the protocol, the method further includes a step of dynamically deploying, for example downloading, a path computation module. The module is then referred to as reprogrammable.

The steps of the method described above are executed by an electronic data processing device, in this instance at least one node of the network, under the control of software instructions. Consequently, the invention also relates to a computer program or software module adapted to be stored in or transmitted by a data medium and including software instructions for execution of the method by an electronic data processing device. The data medium can be a hardware storage medium, for example a CD-ROM, a magnetic diskette or a hard disk, or a transmissible medium such as an electrical, optical or radio signal.

The invention also consists in a system for dynamically managing a quality of service metric in an ad hoc network, the system including routing nodes for routing data packets, characterized in that it further includes a network manager for determining and computing a quality of service metric to be applied at a given time based on the quality of service available on the network and on the quality of service required by one or more applications and means for broadcasting the quality of service metric to be applied to the nodes of the network, each node including a metric manager for updating a routing table of the node as a function of the received quality of service metric to be applied.

Thus the system of the invention includes means for supervising (monitoring) the network in order to have at all times a coherent overview of its status, i.e. the available resources and the resources required by the applications that are running. The quality of service metric to be applied is determined from this data and deployed in the routing protocol by having the nodes of the network periodically exchange information concerning the quality of service metrics by means of control messages of the routing protocol, into which messages the metric to be taken into account is inserted.

The network manager can be integrated into one or more nodes of the network or implemented in a specific mobile or cable terminal having access to a connection to the network.

Routes can be computed at the network nodes as a function of the broadcast quality of service metric by the path computation module specific to the routing protocol or managed externally by an external reprogrammable path computation module shared between applications having the same quality of service requirements or externalized in the applications so that each application is able to select the most pertinent paths given its quality of service constraints.

The invention further consists in a mobile or fixed terminal adapted to form a node in an ad hoc network, characterized in that it includes a metric manager for updating a routing table of said node as a function of an instantaneous quality of service metric to be applied. Such terminals can also include means for periodically taking account of any change of quality of service metric determined as a function of events occurring in the network and in applications.

### BRIEF DESCRIPTION OF THE DRAWINGS

Other features and advantages of the invention emerge from the following description of particular embodiments of the invention given by way of non-limiting example with reference to the appended drawings, in which:

FIG. 1 is a diagram showing the components of the OLSR proactive routing protocol;

FIG. 2 shows one version of an architecture according to the invention;

FIG. 3 shows one example of an ad hoc network topology that has been used to test the method of the invention.

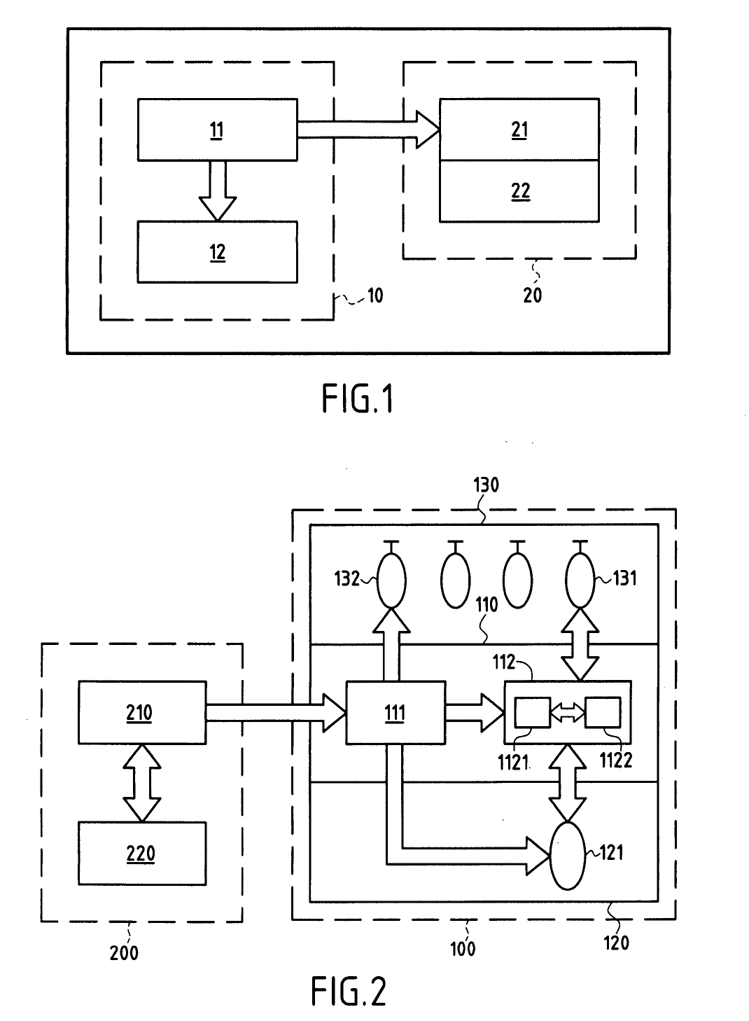

### DETAILED DESCRIPTION OF EMBODIMENTS OF THE INVENTION

The present invention is intended to enable management of quality of service metrics to be externalized to an ad hoc network routing protocol and any type of quality of service metric to be determined, broadcast and taken into account. To this end, the invention proposes a technical solution that employs two main components, one at network level (network manager) and the other at node level (metric manager), together with an extension of the control packets of the routing protocol.

The invention employs and adapts (i.e. extends) a proactive routing protocol and in particular the OLSR protocol, which is one of the best known proactive routing protocols. The OLSR protocol is specified and described in Request For Comments RFC3626 of the MANET (standing for Mobile Ad hoc NETworks) working group of the IETF (Internet Engineering Task Force); see in particular the document “Optimized Link State Routing Protocol (OLSR)”, Network Working Group, T. Clausen et al., October 2003.

To enable deployment and application of any type of quality of service metric in the routing protocol without having to redefine the protocol on each change of metric, the present invention proposes reusing existing messages of the routing protocol rather than defining new messages. The messages used are preferably messages exchanged periodically between the nodes of the network, such as TC (topology control) control messages of the OLSR protocol. Nevertheless, new messages can also be used to transport quality of service metrics.

Thus, according to the invention, generic control messages are used to transport any quality of service metric together with a processing function that constructs in each node a graph of the network topology; each element of the graph is represented by an n-tuple of the form <source-address, destination-addresses, metric1, metric2, . . . , metricN>. This topology is subsequently used for route computation. All quality of service metrics are broadcast to the nodes of the network by means of such messages.

At each node, a metric manager according to the invention is connected to the routing protocol. More precisely, as shown in FIG. 2, a node 100 includes a first layer 110 which corresponds to the layer of the routing protocol 110 that uses a routing table 1121 and a path computation module or algorithm 1122 (this is known in the art). The routing table 1121 is maintained (i.e. updated) locally in each node by the path computation module 1122. The routing table gives the address of the adjacent node to which packets or frames must be sent in order for them to reach their destination in accordance with the defined quality of service metrics.

According to the invention, a metric manager 111 is added in the layer 110 and sends the routing protocol 112 the metric (or combination of metrics) to be applied to the network. Path computation is then based on this metric, using an algorithm that searches for paths in a graph, for example Dijkstra's algorithm in which the values (known as weights) associated with the edges are then given by the values of the selected metrics.

The metric manager is a component distributed to all nodes of the network. In a node it implements the quality of service metric chosen by the network manager. To this end, the metric manager installs in a layer 120 the components 121 needed to insert the quality of service metric into the path computation process. The metric manager 111 also indicates to the routing protocol 112 the existence of external path computation modules 131. The routing protocol can therefore transfer to the external path computation modules a topological view of the network containing the metrics to which the path computation specific to the external module applies.

That transfer can be effected directly or via a specific component, as described in detail in the patent application filed under the number FR 03 12869 and entitled (in translation) “Method of notifying changes of state of resources of a network to at least one application, computer program and change of state notification system for implementing the method”. Two modes are possible:

in push mode the routing protocol sends the relevant modules a topology view periodically;

pull mode is used exclusively at the initiative of the relevant modules, in order for the routing protocol to transfer the topology data to them.

The metric manager uses these quality of service metric components, which can be deployed dynamically or deployed to each node as and when it enters the network, to adapt the instantaneous metric value to suit the immediate vicinity.

The system of the invention further includes means for determining the quality of service metric or metrics that the nodes must take into account for routing purposes. The network manager 200 is an entity that can be integrated into one or more nodes of the network or implemented in a specific mobile or cable terminal having access to a connection to the network.

As shown in FIG. 2, a network manager 200 includes a quality of service metric determination module 210 connected to a supervision module 220 that supervises the status of the resources of the network in relation to events (node disappearance/appearance, bandwidth capacity reduction/increase, energy, etc.) as and when they occur and the resources required by the applications that are running. To this end, any new application must register with the network manager, specifying its quality of service requirement (for example, a voice over IP application specifies a maximum delay of 250 ms). The manager therefore has an overview of all application requirements. Information concerning the status of the network resources is fed back to the module 220 by means of probes installed in each node (i.e. each user terminal). An information exchange rules base can be provided in the supervision module to enable it to process events that are fed back to it.

The determination module 210 integrates logic for deciding the metric to be applied in the network as a function of the status of the network resources and/or the requirements of the applications as indicated by the supervision module 220. When a new notification is received from the supervision module, the determination module is invoked and the quality of service metrics to be deployed are determined.

Once it has been made, the decision regarding the quality of service metrics is broadcast by the network manager to the metric managers of all the nodes of the network in order for them to implement it. However, an exchange protocol is defined for sending configuration instructions from the network manager to the metric manager. This exchange is effected via reliable atomic transmission mechanisms. This protocol includes the following functions:

DeployQoSMetric (metric): this function deploys a given quality of service (QoS) metric over the network, i.e. the control packet computation and insertion modules.

SuppressQoSMetric (metric): invoking this function means that the metric in question is no longer taken into account.

DeployPath (module): this function activates an external path computation module.

SuppressPath (module): this function deactivates a previously activated path computation module.

In order not to degrade network operation, given that an ad hoc network is a network with resources that vary in time, tolerance thresholds (minimum energy level, maximum load level, etc.) can be set in the nodes of the network.

In one embodiment, the routing process can be managed externally via a path computation module 131 that is deployed dynamically in a layer 130. Under such circumstances, the existing routing protocol 112 uses the path computation module 131 instead of its internal module 1122. The routing protocol 112 sends the module 131 the topology graph enriched with the quality of service information supplied by the metric computation module 132 at each node. The applications must be modified to take account of the new module, which can be either specific to each application or shared by a number of applications. When shared the module is transparent to the applications because the result of computing metrics is injected back into the routing protocol with which the application is communicating. Whether the module is shared or not, this new route computation imposes no or very little modification of the initial routing protocol. Moreover, this external module can be reprogrammed at any time, enabling it to integrate new metrics dynamically at the initiative of the metric manager. This enables external management of quality of service and path computation metrics. Thus the routing topology can be managed using quality of service metrics at the application level so that they can apply the form of path computation that represents the optimum given their quality of service requirement.

Interactions between the FIG. 2 components are described first below by means of an imaginary example. A second example is then described which shows one possible use of the present invention.

### Description of Interactions

A spontaneous ad hoc network that is formed in an area with no infrastructure is considered by way of example. By default the topology discovery protocol included in the routing protocol 130 does not include any specific quality of service metric. If a node in the network is solicited by a voice over IP (VoIP) application that requires constant bit rate (CBR) traffic characteristics, a new metric must be exchanged between the nodes and a specific path computation based on that metric set up to define an optimized path for the VoIP application. A first step chooses the metric available in the network that is closest to that needed by the application. This may be the jitter metric, for example, the delay metric or by default the number of hops. This decision can be local to the node, which propagates it to the other nodes (in accordance with the well-known principle of self-organized networks), or a global decision by the network manager 200, which sends it to the nodes via a specific control message, as described above. The externalized computation module 131 associated with the chosen metric, for example the delay metric, is then activated in each node or possibly deployed dynamically from the network manager. The chosen metric, here the delay metric, is then also added to control messages exchanged between the nodes by the routing protocol to discover and maintain the topology. When the VoIP application seeks to set up a call, it invokes the externalized path computation module specific to the chosen metric, here the delay metric. That module can be present at all the nodes or deployed dynamically. It recovers from the routing protocol the topology graph with the delay metric (information concerning the metric is computed by the metric computation module at each node and transported by the routing protocol control packets). Moreover, other applications use the default path computation module, i.e. the number of hops. The VoIP application then has access to routes that are suited to its delay constraint while other applications have paths that may be shorter but may also be more heavily loaded. This is not a problem for a data exchange application, for example.

### Example of Use

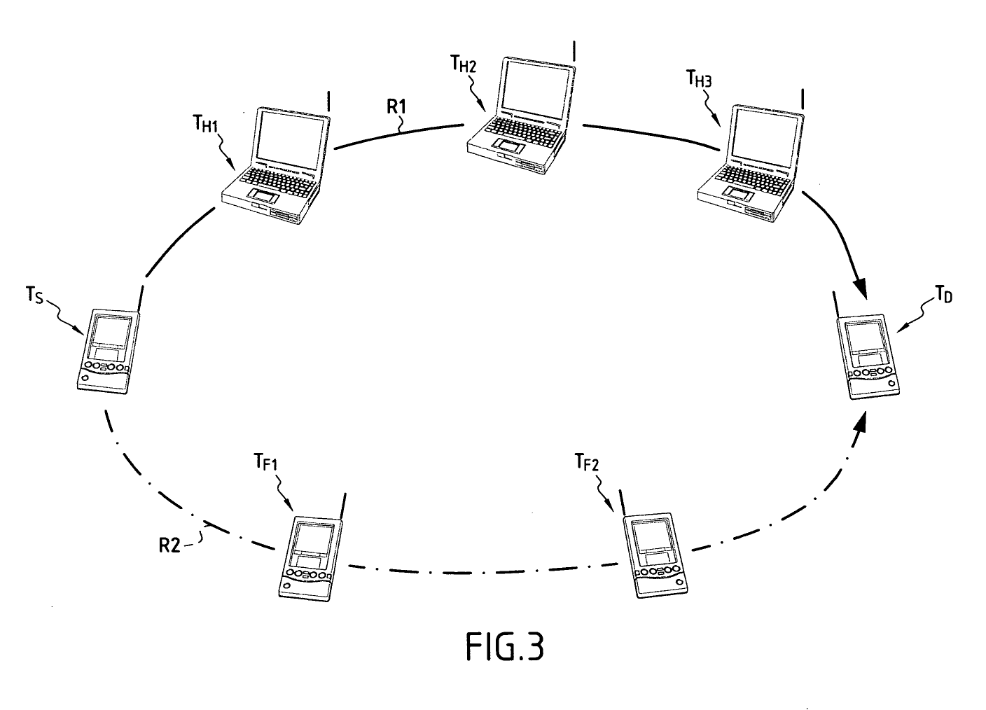

A particular example of the use of the invention is described with reference to FIG. 3, which shows one example of an ad hoc network topology with a configuration that shows up the limitations of current solutions based on fixed metrics and the advantages of the invention in terms of dynamic adaptation to changing quality of service conditions in the environment of the network (applications and network status). The network shown in FIG. 3 includes seven nodes formed by seven terminals of two types: three high-capacity terminals (personal computers (PC)) T_{H1}, T_{H2} and T_{H3} forming a first route R1 and four low-capacity terminals (personal digital assistants (PDA)) T_{S}, TF₁, TF₂, T_{D}, the terminals TF₁ and TF₂ forming a second route R2 between a source node and a destination node respectively formed by the terminals T_{S} and T_{D}.

All nodes use 11 Mb/s 802.11b wireless interfaces. The route R1 consisting of three PCs is better for routing if the delay metric is used while the route R2 consisting of the two PDAs is better for routing based on the bandwidth metric.

This particular example considers two applications involving two different types of traffic, each with different requirements: the first application (for example file transfer, http, etc.) uses the transfer control protocol (TCP) with the emphasis on bandwidth and the second uses the somewhat more real time user datagram protocol (UDP) for which the emphasis is on delay (for example multimedia transmission).

The metric “switching” rules for this test network are defined by the following algorithm:

```
Start
    If (Event = Deterioration of
    low_capacity_node resources) then metric =
    Reliable nodes.
    Else (other events)
    If (no conflict between applications) then
    metric = default metric of applications.
    /*same metric for all applications*/
    Else metric = delay. /*preferred metric*/
    End.
```

This data is used to select the metric to be applied in the network according to rules defined in the network manager. Depending on the decision, data is routed either via the route R1 (delay metric) or via the route R2 (bandwidth metric).

The table below shows the behavior of the approach according to the invention. More precisely, it defines the metric to be applied in the network as a function of events occurring in the network.

| Time | | Metric selected and |
|---|---|---|
| (seconds) | Event | used |
| T0 | Starting of | Bandwidth |
| | application 1 | (route 2) |
| | (priority: bandwidth) | |
| T1 | Deterioration of CPU | Reliable nodes (route |
| | resources of PDAs | 1) |
| T2 | Starting of | Delay |
| | application 2 | (route 1) |
| | (priority: delay) | |
| T3 | End of application 1 | Delay (route 1) |
| T4 | End of application 2 | Reliable nodes (route |
| | | 1) |

Given the above results, it is clear that the choice of the metric applied in the ad hoc network has a major impact on the quality of service rendered to the application, as a function of what it needs.

As for the results, note that applying the bandwidth metric achieves good performance at bandwidth level, to the detriment of delay, which is very significantly increased. This is advantageous for applications that need a high bandwidth, although applications sensitive to delay are strongly penalized. The opposite phenomenon is seen with the delay metric: the delay is reduced but the bandwidth is less than that obtained with the bandwidth metric.

The invention nevertheless achieves the best compromise in terms of applying the metric that is the best instantaneous response to the needs of applications given the environmental constraints.

The results obtained in this example demonstrate the efficacy of dynamic management of the quality of service metric. Unlike a rigid, fixed metric approach, dynamic management of the quality of service metric offers sufficient flexibility to address optimally the quality of service policies defined in the network.

1. A method of dynamically adapting a quality of service metric for routing in an ad hoc network including a plurality of routing nodes (100) for optimum routing of data packets between the nodes depending on the topology of the network at a given time, said method including the steps of:
a) determining a quality of service metric to be applied at a given time based on the quality of service available on the network and/or on the quality of service required by one or more applications;
b) sending the quality of service metric to be applied to at least some network nodes; and
c) updating a routing table (1121) of the nodes as a function of the received instantaneous quality of service metric to be applied.

2. The method according to claim 1, wherein, in step a), a reprogrammable network manager (200) supervises the status of the resources of each node (100) on the basis of the quality of service metrics to be applied at a given time and the resources required by applications running on the network.

3. The method according to claim 1, wherein, in step b), the quality of service metric to be applied is inserted into control messages of the routing protocol.

4. The method according to claim 1, wherein the method further includes a step of external management of the quality of service metrics and of path computation by modules managed by a given application or by reprogrammable modules (131) shared by a plurality of applications.

5. A computer program including instructions for executing the method according to claim 1.

6. A storage medium storing the program according to claim 5.

7. A system for dynamically managing a quality of service metric in an ad hoc network, the system including routing nodes (100) for routing data packets, wherein the system further includes a network manager (200) for determining and computing a quality of service metric to be applied at a given time based on the quality of service available on the network and on the quality of service required by one or more applications and means for broadcasting the quality of service metric to be applied within said network to the nodes of the network, each node including a metric manager (111) for updating a routing table (1121) of the node as a function of the received quality of service metric to be applied.

8. The system according to claim 7, wherein the network manager includes means (220) for supervising the status of the resources of each node and the resources required by the applications running on the network.

9. The system according to claim 7, wherein the system includes means for computing and inserting the quality of service metric into control messages of the routing protocol.

10. The system according to claim 7, wherein the network manager (200) is integrated into one or more nodes of the network or the system further includes a mobile or cable terminal connected to the network and integrating the network manager.

11. The system according to claim 7, wherein the system further includes means for sending network nodes reprogrammable path computation and quality of service metric management software modules (131, 132).

12. The system according to claim 7, wherein the system further includes means for managing the routing topology with quality of service metrics in the applications so that they can apply the optimum path computation given the quality of service they need.

13. A mobile or fixed terminal adapted to form a node (100) in an ad hoc network, comprising a quality of service metric determined and transmitted to said node using the method as defined in claim 1, and wherein said terminal includes a metric manager (111) for updating a routing table (1121) of said node as a function of a quality of service metric transmitted in the network.
